(19) United States
(12) Patent Application Publication
(10) Pub. No.: US 2026/0169764 A1
(43) Pub. Date: Jun. 18, 2026

(54) SUPPORTING ASSESSMENT OF USER INTERACTIONS WITH CONTENT

(71) Applicant: Doximity, Inc., San Francisco, CA (US)

(72) Inventors: Jeffrey Alan Tangney, Palo Alto, CA (US); Jey Balachandran, New York, NY (US); John Stuart Noble, Chicago, IL (US); Andrew Jayhoon Chung, San Francisco, CA (US); Jared Scheer, East Meadow, NY (US); Ricardo Andres Flores, Macomb, MI (US); Jose Rodolfo Ordonez, Tarzana, CA (US); Christopher Joseph Albanese, San Francisco, CA (US); Claire Pengelly, Easton, NH (US); Austen Kayn Madden, Columbus, OH (US)

(21) Appl. No.: 18/980,750

(22) Filed: Dec. 13, 2024

(51) Int. Cl. G06F 9/451

(52) U.S. Cl. CPC G06F 9/451

(57) ABSTRACT

A processing device may determine a set of values for a metric corresponding to an effect of content based on interaction data associated with the content. A plot of the set of values for the metric may be overlaid on a graphical user interface (GUI) view of a first portion of the content.

### FIELD OF DISCLOSURE

This disclosure relates generally to user interactions with content, and more particularly to supporting assessment of user interaction with content.

### BACKGROUND

Users of computing devices are regularly presented and interact with content, such as videos and documents. Much of the content presented to users is associated with various enterprises seeking to achieve particular objectives through presentation of the content, such as promoting user awareness or causing users to purchase a product. Accordingly, these enterprises and the interested parties behind these enterprises (referred to herein as clients) strive for content that users will reliably and effectively interact with.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

To easily identify the discussion of any particular element or act, the most significant digit or digits in a reference number refer to the figure number in which that element is first introduced.

FIG. 1 illustrates an exemplary operating environment for supporting assessment of user interactions with content according to some embodiments of the present disclosure.

FIG. 2 illustrates various aspects of a user graphical user interface (GUI) provided by a networking platform according to some embodiments of the present disclosure.

FIGS. 3A-3D illustrate various aspects of a client GUI provided by a networking platform according to some embodiments of the present disclosure.

FIGS. 4A and 4B illustrate exemplary content views according to some embodiments of the present disclosure.

FIG. 5 illustrates a flow diagram of a method for supporting assessment of user interactions with content according to some embodiments of the present disclosure.

FIG. 6 illustrates a block diagram of an example system for supporting assessment of user interactions with content according to some embodiments of the present disclosure.

FIG. 7 illustrates a block diagram of an example system according to some embodiments of the present disclosure.

FIG. 8 illustrates exemplary aspects of a communications architecture according to some embodiments of the present disclosure.

### DETAILED DESCRIPTION

The following description sets forth numerous specific details such as examples of specific systems, components, methods, and so forth, in order to provide a good understanding of various embodiments of the techniques described herein for supporting assessment of user interactions with content. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Networking platforms generally operate to facilitate the dissemination of information to various consumers. For example, a networking platform may provide a source of healthcare information to healthcare professionals. This information, or content, may be presented to and consumed by users in a variety of different formats and from a variety of different sources. One source of the content includes clients. For example, clients may utilize the networking platform to introduce or promote desired content to users. Existing networking platforms, however, fail to provide functionality that adequately supports accurate and reliable assessments of content performance by clients. For example, existing systems cannot provide user interaction metrics in conjunction with content in a dynamic manner that informs clients on how users are interacting with each portion of the content. In another example, clients are not provided with an interactive GUI that functions to automatically determine and surface corresponding content and relevant metrics in response to a client identifying a point of interest. This leads to an inability to readily identify poorly performing portions of content in an intuitive, efficient, and dynamic manner. Adding further complexity, existing systems fail to surface reliable metrics. For example, values underlying metrics may not be properly filtered, such as by including multiple interactions by a single user, resulting in inaccurate representations of content performance. These limitations can drastically reduce the accessibility, usability, reliability, and capabilities of networking platforms, contributing to systems with limited functionality and poor client experiences.

Accordingly, many embodiments disclosed hereby provide various techniques, functions, and features for supporting assessment of user interactions with content, such as articles and videos. For example, a metric corresponding to an effect of content may be determined based on interaction data associated with the content and a plot of the metric may be overlaid on a GUI view of the content. More generally, many embodiments may monitor user interactions with content, such as by analyzing data received via a computer network from a plurality of user devices. The user interactions may further be analyzed and filtered to generate reliable and accurate metrics corresponding to the content as well as different portions of the content. Several embodiments are particularly directed to an intuitive interface that utilizes the metrics to enable clients to understand how their content is performing and readily identify portions that negatively affect performance of their content. To this end, various embodiments include a GUI with a first layer corresponding to the content and a second layer corresponding to user interactions with the content. Various such embodiments dynamically update the first and second layers based on points of interest identified based on client input received via the GUI. For example, a user-view layer including content and a performance layer including a semi-transparent plot overlaid on the content. In various such examples, the portion of the content displayed in the performance layer may be dynamically updated based on a point of interest, such as a location in the semi-transparent plot. In some embodiments, the performance layer may illustrate dismissal rates for the content over time that are calculated based on monitoring of user interactions. In several embodiments, user interactions with content may be filtered, such as by consolidating multiple interactions by a single user, to ensure that presented metrics are accurate and reliable. Accordingly, embodiments described hereby provide new and useful computer-based functionality to support the assessment of user interactions with content in a reliable and efficient manner.

In these and other ways, components/techniques described hereby may provide many technical advantages for supporting assessment of user interactions with content. For example, performance of different portions of content can collectively be presented in a composite and understandable manner that readily enables a client to drill down to specific portions of the content. Further, the techniques and features described hereby provide particular ways of programming or designing software to determine and present metrics on user interactions with client content. Further, the techniques and functionalities provide a specific interface and implementation for navigating and evaluating complex interactions with a multitude of content items of various formats in an intuitive and efficient manner using techniques unique to computers, such as a dynamically updated graphical user interfaces with multiple layers that present performance metrics calculated based on analysis of monitoring data received via a computer network, for example. Therefore, the computer-based techniques of the current disclosure improve the functioning of networking platforms, resulting in better capabilities and improved user experiences as compared to conventional approaches. Accordingly, embodiments disclosed hereby can be practically utilized to improve the functioning of a computer and/or to improve a variety of technical fields including networking platforms, content analysis, user interfaces, user experience, and human-machine interfaces.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

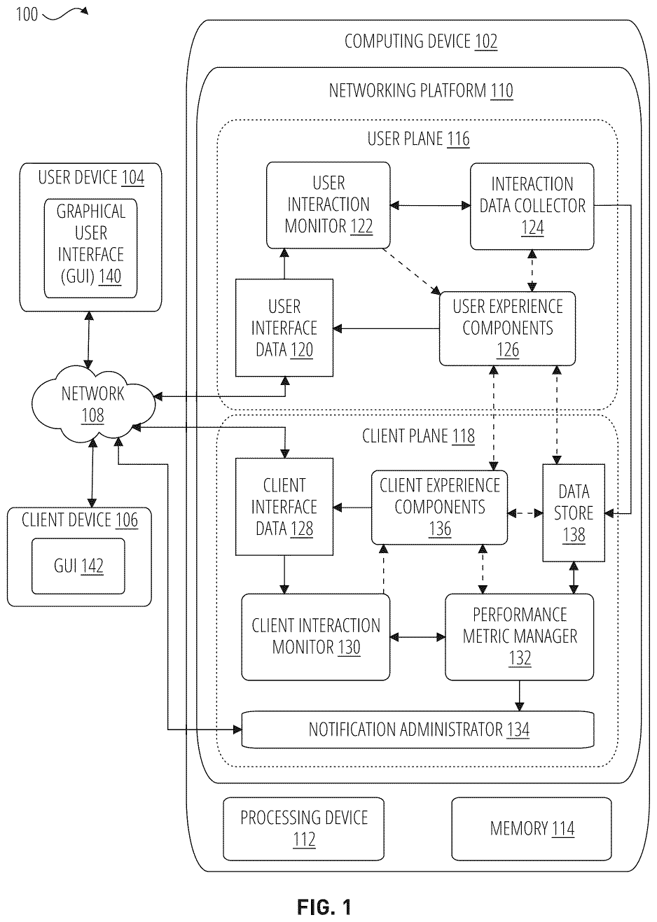

FIG. 1 illustrates an operating environment 100 for supporting assessment of user interactions with content according to some embodiments. Operating environment 100 includes a computing device 102, a user device 104, a client device 106, and a network 108. The computing device 102 includes a networking platform 110, a processing device 112, and a memory 114. The user device 104 includes a first graphical user interface (GUI) 140 and the client device 106 includes a second GUI 142. The GUI 140 of the user device 104 may be utilized to interact with a user plane 116 of the networking platform 110 via network 108 and the GUI 142 of the client device 106 may be utilized to interact with a client plane 118 of the networking platform 110 via network 108. Generally, the user plane 116 may be utilized by consumers of content on the networking platform 110 (referred to as users) and the client plane 118 may be utilized by providers of content to the networking platform 110 (referred to as clients). In many embodiments, the techniques disclosed hereby relate to providing new and useful techniques to enable a client to more accurately and reliably assess interactions of users with content provided by the client, such as by tracking, determining, and presenting metrics corresponding to user interactions with content on the networking platform 110. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, the networking platform 110 may be implemented by multiple computing devices in multiple locations without departing from the scope of this disclosure. In another example, the data store 138 may be separate from the client plane 118 or at least partially included in the user plane 116 without departing from the scope of this disclosure. Embodiments are not limited in this context.

The networking platform 110 may operate to facilitate the dissemination of information to users of the networking platform 110. For example, the networking platform 110 may provide a source of healthcare information to healthcare professionals. This information, or content, may be presented to and consumed by users in a variety of different formats and from a variety of different sources. One source of the content includes clients. For example, clients may utilize the networking platform 110 to introduce or promote desired content to users. In various embodiments described hereby, the networking platform 110 may include various techniques and functionalities to assist clients in assessing the performance of provided content via user interactions with the content.

The user plane 116 of networking platform 110 includes user interface data 120, a user interaction monitor 122, an interaction data collector 124, and one or more user experience components 126. As previously mentioned, the user plane 116 may be utilized by consumers of content on the networking platform 110. For example, a user may utilize the GUI 140 on user device 104 to log into and consume content from the networking platform 110 via network 108. Accordingly, the components of user plane 116 may support user interactions with the networking platform 110. In various embodiments, this may be achieved, at least in part, by the dynamic generation and exchange of instances of user interface data 120 between user device 104 and the components of the user plane 116. For example, at a first instance user interface data 120 may include data indicative of a selection made by a user on GUI 140 and at a second instance user interface data 120 may include content provided to the user device 104 by networking platform 110 in response to the selection made by the user. In many embodiments, user interface data 120 may include interaction data associated with content.

The client plane 118 of networking platform 110 includes client interface data 128, a client interaction monitor 130, a performance metric manager 132, a notification administrator 134, one or more client experience components 136, and a data store 138. As previously mentioned, the client plane 118 may be utilized by content providers on the networking platform 110. For example, a client may utilize the GUI 142 on client device 106 to provide content to and analyze performance of content on the networking platform 110 via network 108. Accordingly, the components of client plane 118 may support client interactions with the networking platform 110. In various embodiments, this may be achieved, at least in part, by the dynamic generation and exchange of instances of client interface data 128 between user device 104 and the components of the user plane 116. For example, at a first instance client interface data 128 may include data indicative of performance metrics corresponding to client content and provided to the client device 106 by networking platform 110 and at a second instance client interface data 128 may include data indicative of a point of interest selected by a user via GUI 142 in response to presentation of the performance metrics. As described in more detail below, components of the client plane 118 may operate in conjunction with components of the client plane 118 to determine metrics corresponding to user interactions with clients, such as a metric associated with cessation of user interactions with content.

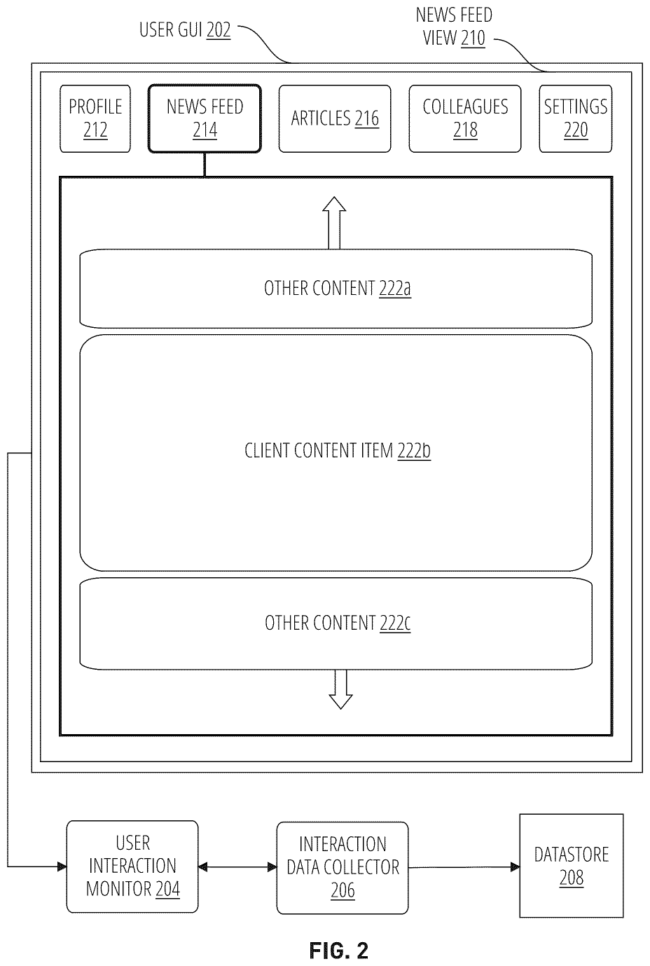

Referring to interactions between user device 104 and the networking platform 110, an exemplary operational flow for the networking platform 110 may proceed as follows. A user may be presented various content and may interact with the various content via GUI 140 of user device 104. Presentation of the various content via the user device 104 is described in more detail below, such as with respect to FIG. 2. User interface data 120 may be generated and transmitted to the user plane 116 via network 108 based on the user input provided via GUI 140. User interaction monitor 122 may analyze the user interface data 120 to inform various user experience components 126 on what data should be provided in response (e.g., included in user interface data 120 provided back to user device 104). For example, user interaction monitor 122 may track cursor position, clicks, dwell time, view time, scroll position, and the like.

Additionally, user interaction monitor 122 may identify the portions of the user interface data 120 that corresponds to the user interactions and provide this data to interaction data collector 124. For example, user interaction monitor 122 may identify interaction data associated with content. In some embodiments, the user interaction monitor 122 may provide the interaction data to the interaction data collector 124. In some such embodiments, the user interaction monitor 122 may provide an indication of the content associated with the interaction data to the interaction data collector 124. In response, interaction data collector 124 may store the interaction data in the data store 138. In various embodiments, interaction data collector 124 may perform one or more operations on the interaction data prior to storing it in data store 138. For example, interaction data collector 124 may classify, format, condition, filter, tag, and/or normalize the interaction data prior to storing it in data store 138. In one embodiment, the interaction data collector 124 may associate (e.g., tag) the interaction data with various items of related information, such as related content items, classifications, portions of content, clients, users, where/how the content was presented, and the like prior to storing the user interaction data in data store 138. For example, interactions may be classified based on interaction depth (e.g., <5 seconds classified as light engagement and >5 seconds classified as deep engagement). It will be appreciated that similar procedures may occur for a plurality of users on a plurality of user devices to populate the data store 138 with user interaction data. Additionally, one or more of these operations may be performed by other components of the networking platform 110 without departing from the scope of this disclosure. For example, the operations performed on the user interaction data prior to storing it in the data store 138 may alternatively be performed by the performance metric manager 132 after the data is stored in data store 138.

Referring to interactions between user device 104 and the networking platform 110, an exemplary operational flow for the networking platform 110 may proceed as follows. A client may access the networking platform 110 via client device 106 and utilized GUI 142 to navigate to a library of client content. Client interface data 128 may be generated and transmitted to the client plane 118 via network 108 based on the client input provided via GUI 140 selecting a content item from the library of client content. Client interaction monitor 130 may analyze the client interface data 128 to inform various client experience components 136 on what data should be provided in response (e.g., included in user interface data 120 provided back to user device 104). For example, client interaction monitor 130 may track cursor position, clicks, dwell time, view time, scroll position, and the like. Additionally, client interaction monitor 130 may inform the performance metric manager 132 that a portion of the client interaction monitor 130 corresponds to selection of a particular content item. In response, the performance metric manager 132 may query the data store 138 to obtain user interaction data relevant to the particular content item.

The performance metric manager 132 may then determine one or more user interaction metrics and a set of corresponding values based on the client interaction data relevant to the particular content item. More generally, the performance metric manager 132 may operate to determine and/or generate data and metrics that support client assessment of user interactions and/or cessation of user interactions with content. A dismissal may correspond to an action by the user that causes the content to cease being presented to the user. For example, a dismissal may include closing the content or scrolling past the content. On the other hand, an interaction may include having the content displayed or playing on the user interface.

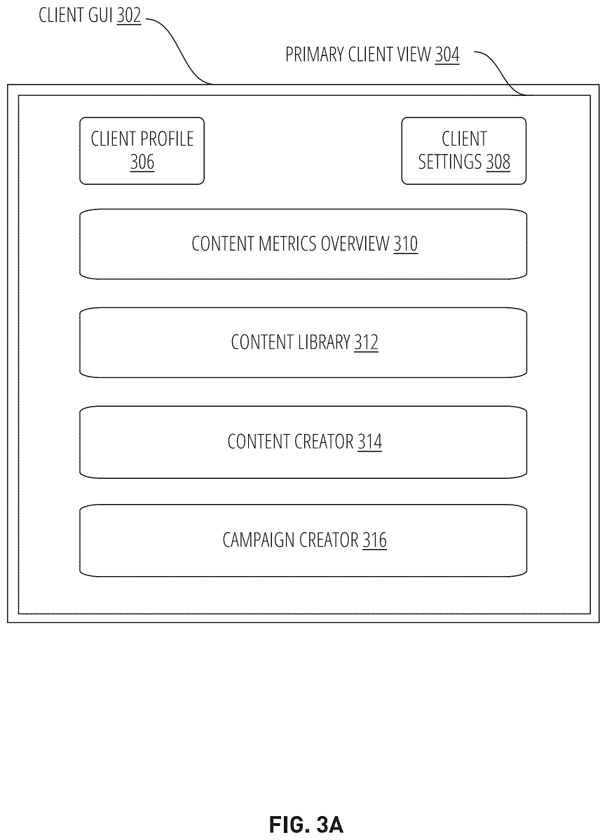

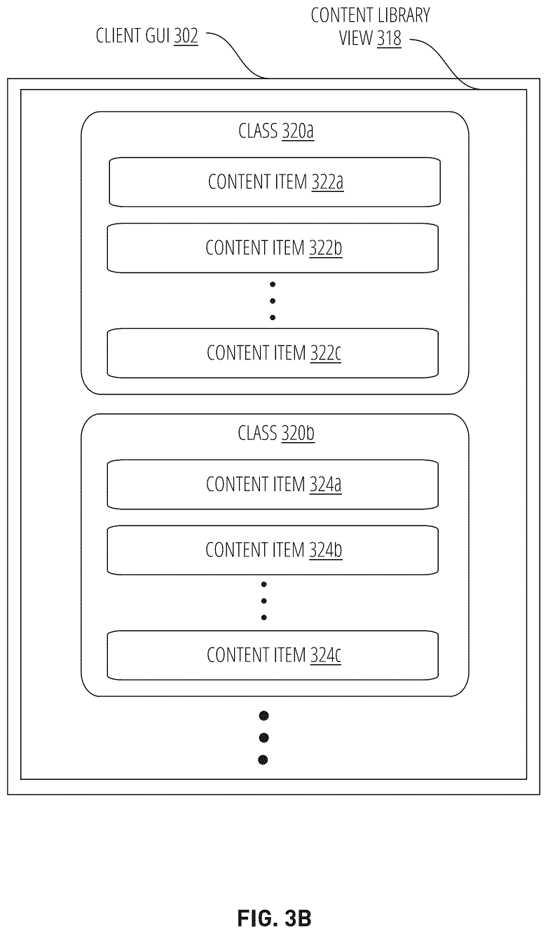

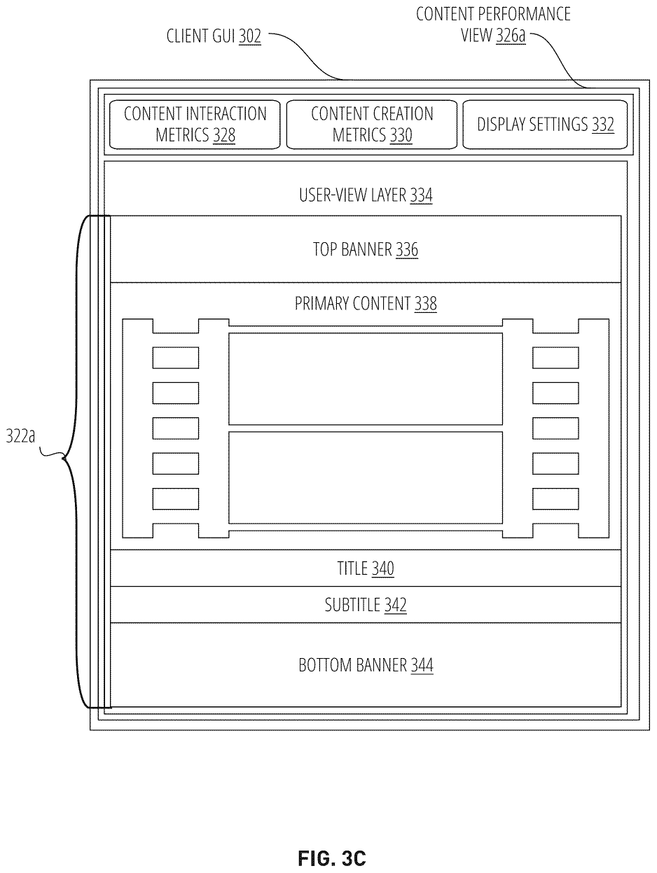

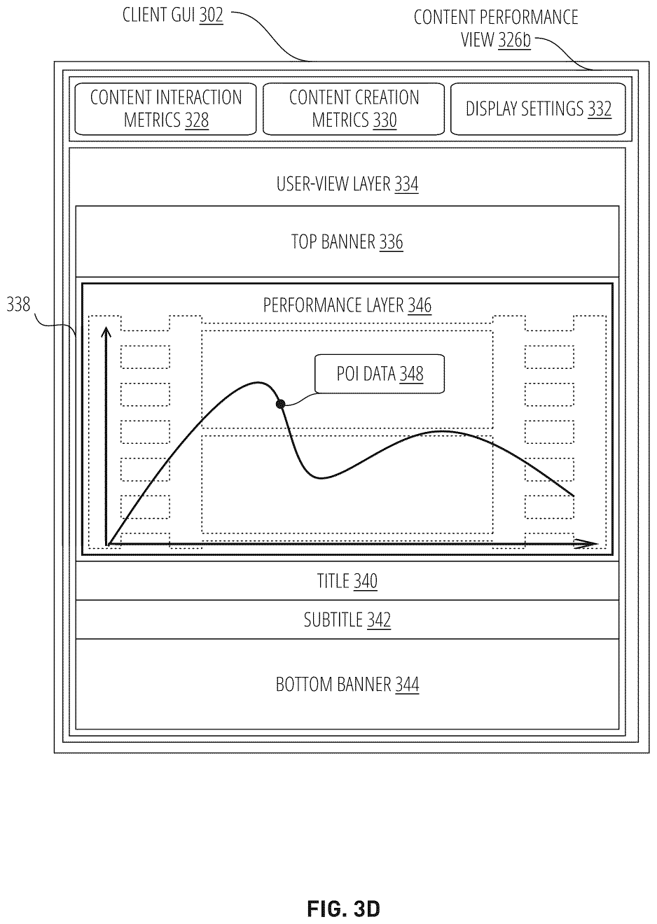

In some embodiments, if the particular content item includes a video, the performance metric manager 132 may determine dismissal rates for the video. In various embodiments, the dismissal rates for the video may include a set of values corresponding to the dismissal rate for each second of the video. In one embodiment, a dismissal rate may include a number of users viewing the video at a first instant of time compared to a number of users viewing the video at a second instant of time preceding the first instant of time. For example, the number of users viewing the video at time 12 seconds compared to the number of users viewing the video at time 11 seconds. In various embodiments, this may be referred to as the instantaneous dismissal rate. In some embodiments, the instantaneous dismissal rates may be further modified or conditioned prior to being presented to the client. For example, a rolling average, such as a 2-second rolling average of the instantaneous dismissal rate may be included in client interface data 128 transmitted to the client device 106 for presentation to the client. In another embodiment, the particular content item may include a textual article. Accordingly, metrics such as scroll depth, dwell time, portion of focus (e.g., portion of article with largest dwell time) may be determined by the performance metric manager 132 and included in client interface data 128. Additionally, the client interface data 128 may include data to inform the GUI 142 of client device 106 on how to present the information, such as in a plot of the metric in a performance layer of a content performance view of the GUI 142. Presentation of the user interaction metrics and values via the client device 106 is described in more detail below, such as with respect to FIGS. 3A-3D.

In various embodiments, the performance metric manager 132 may perform various operations on the user interaction data retrieved from the data store 138 prior to determining metrics and/or corresponding values. In various such embodiments, the performance metric manager 132 may deduplicate, filter, or consolidate the data, such as based on parameters and thresholds. For example, the performance metric manager 132 may identify the most significant interaction each user had with the content and filter out the remaining user interaction data. In some such examples, the most significant interaction with content may refer to their longest interaction with the content (e.g., the longest amount of a video viewed by each user). In another example, user interactions that do not exceed a threshold amount of time (e.g., 1 or 2 seconds) may be filtered out. In many embodiments, these operations performed on the user interaction data prior to determining metrics and/or corresponding values may be utilized to ensure that the data presented to clients is accurate and reliable. It will be appreciated that, one or more of these operations may be performed by other components of the networking platform 110 without departing from the scope of this disclosure. For example, the operations performed on the user interaction data by performance metric manager 132 may be performed by interaction data collector 124 prior to being stored in the data store 138.

The notification administrator 134 may be configured to provide notifications to clients when certain thresholds or conditions are met with respect to content performance. For example, if content has a dismissal rate over a specified threshold, a notification may be sent to the client device or one or more other devices. In some embodiments, the notifications may be included in client interface data 128. In one embodiment, the notifications may be included in emails.

It should be noted that although a single processing device 114 and a single memory 116 are depicted in the computing device 102 of FIG. 1 for simplicity, other embodiments may include multiple processing devices, storage devices, or devices. Processing device 116 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. processing device 114 may also include one or more special-purpose processing devices such as an application specific integrated circuit (ASIC), a field programmable gate array (FPGA), a digital signal processor (DSP), network processor, or the like. Further details regarding supporting communication between different browsing contexts will be discussed below.

FIG. 2 illustrates various aspects of a user GUI 202 provided by a networking platform according to some embodiments. The illustrated embodiment includes the user GUI 202, a user interaction monitor 204, an interaction data collector 206, and a datastore 208. The user GUI 202 may be utilized by users to interact (e.g., view, access, consume, etc.) with content provided by the networking platform. The interaction data collector 206 may operate to populate a datastore 208 with data regarding user interactions with content based on output of the user interaction monitor 204. One or more components of FIG. 2 may be the same or similar to one or more other components disclosed hereby. For example, user GUI 202, interaction data collector 206, datastore 208, and/or news feed view 210 may be the same or similar to GUI 140, user interaction monitor 122, interaction data collector 124, and/or user experience components 126, respectively. Further, aspects discussed with respect to various components in FIG. 2 may be implemented by one or more other components from one or more other embodiments without departing from the scope of this disclosure. Embodiments are not limited in this context.

The user GUI 202 may provide a variety of ways for users to interact with the networking platform and content provided via the networking platform. For example, a user may access their profile 212, a news feed 214, articles 216, colleagues 218, and settings 220 via the user GUI 202. The illustrated embodiment includes a news feed view 210 that enables users to interact with content. The news feed view 210 may include a view that allows users to scroll through various items of content. This content may include content from a variety of sources, such as other users, third-party sources, and clients. In the exemplary embodiment of FIG. 2, this content includes other content 222a, client content item 222b, and other content 222c.

Additionally, other views may be available for users to interact with content. For example, selecting articles 216 may provide users with a view that focuses on content from academic publications and selecting colleagues 218 may provide users with a view that focuses on content provided by colleagues (or other professionals) on the networking platform. Each of these views may also include client content. In some embodiments, client content may be provided to users of the networking platform based on contractual agreements between the networking platform and various clients. In various embodiments, the user interaction monitor 204 may monitor the interactions of users with content presented to them. Interaction data collector 206 may generate data based on these interactions, such as view time, and store this data in datastore 208, as described in more detail above.

FIGS. 3A-3D illustrate various aspects of a client GUI 302 provided by a networking platform according to some embodiments. More specifically, FIG. 3A includes a primary client view 304 of the client GUI 302, FIG. 3B includes a content library view 318 of the client GUI 302, FIG. 3C includes a first content performance view 326a of the client GUI 302, and FIG. 3D includes a second content performance view 326b of the client GUI 302. Generally, the client GUI 302 may enable a client to configure and manage content on the networking platform. Advantageously, the client GUI 302 facilitates assessment of the content by clients based on user interactions with the content, such as by enabling clients to view various information, insights, and metrics regarding user interactions with content they have provided to the networking platform. One or more components of FIGS. 3A-3D may be the same or similar to one or more other components disclosed hereby. For example, client GUI 302, client interaction monitor 346, performance metric manager 346, and/or datastore 346 may be the same or similar to GUI 142, client interaction monitor 130, performance metric manager 132, and/or data store 138, respectively. Further, aspects discussed with respect to various components in FIGS. 3A-3D may be implemented by one or more other components from one or more other embodiments without departing from the scope of this disclosure. Embodiments are not limited in this context.

Referring to FIG. 3A, the client GUI 302 may provide a variety of functions, interfaces, and views for a client to interact with the networking platform. In the primary client view 304, a client may be provided with access to a client profile 306, client settings 308, a content metrics overview 310, a content library 312, a content creator 314, and a campaign creator 316. The client profile 306 may allow clients to view account information, such as client information, privileges, subscriptions, and the like. In various embodiments, one or more thresholds or parameters disclosed hereby, such as filters and thresholds for basing user interaction metrics or notification triggers may be defined via the client settings 308. Content metrics overview 310 may include various overview data corresponding to content of a client, such as a summary view of the performance of client content. For example, the content metrics overview 310 may include at least one of unique healthcare providers targeted, light engagements, deep engagements, percent of targets deeply engages, tactics utilized, pacing to guarantee, and top engagers. Additionally, some embodiments may include functionality to export various content metrics, such as physician level data. In some embodiments, the performance of client content may be compared to target benchmarks in the content metrics overview 310.

The content library 312 may enable a client to view the content they have provided to the networking platform. As described in more detail below, such as with respect to FIG. 3B, in various embodiments, clients may access performance metrics for each item of content via the content library 312. The content creator 314 may provide clients with various tools for creating, uploading, formatting, and testing content on the networking platform. For example, the content creator 314 may enable clients to preview how content will be presented to users on the platform. In another example, the content creator 314 may enable clients to add banners, titles, subtitles, content (e.g., primary content), and the like to configure or create a content item. The campaign creator 316 may enable clients to promote content to users as well as configure the promotion of the content, such as by selecting where on the networking platform the content is presented (e.g., in the news feed).

Referring to FIG. 3B, the content library view 318 of client GUI 302 may include a plurality of content items (e.g., content items 322a, 322b, 322c, 324a, 324b, 324c) that have been provided or created by the client. In various embodiments, the content items may be associated with different classifications in the content library. In the illustrated embodiment, content items 322a, 322b, 322c belong to class 320a and content items 324a, 324b, 324c belong to class 320b. These classes may be utilized to organize the content according to one or more parameters. For example, each class may include content associated with a particular campaign. In another example, each class may correspond to types of content, such as videos and articles. A client may be able to select various content items from the content library 312. In many embodiments, various operations by the performance metric manager (e.g., performance metric manager 132) may be triggered in response to selection of a content item. For example, user interaction data related to the content item may be retrieved from the datastore, various metrics may be determined by the performance metric manager, and/or metric values may be provided to the client device in response to selection of a content item in the content library 312. It will be appreciated that one or more of these operations may be triggered by other actions without departing from the scope of this disclosure.

Referring to FIG. 3C, in response to selecting content item 322a, the content performance view 326a may be presented via the client GUI 302. The content performance view 326a includes a user-view layer 334 that presents the content item 322a to the client. In many embodiments, the content item 322a may be presented in the same format that it would be presented to a user. In the illustrated embodiment, the content item 322a includes a top banner 336, primary content 338, a title 340, a subtitle 342, and a bottom banner 344. Generally, as described hereby, reference to user interactions with content may refer to user interactions with the primary content (e.g., a video) included in a content item. For example, although the entire content item may be presented to users, user interaction metrics, such as dismissal rates, may be determined based on user interaction with the primary content. In some embodiments, however, interactions with other parts of the content item may be tracked and utilized to generate metrics, such as clicks of a link included in the top banner 336 or bottom banner 344.

Additionally, the content performance view 326a may include content interaction metrics 328, content creation metrics 330, and display settings 332. The content interaction metrics 328 may include various summary metrics associated with one or more portions of the content item, such as the primary content 338. For example, content interaction metrics 328 may include total views of the content item, light engagements with the primary content 338 (e.g., video plays for less than a threshold amount of time), deep engagements with the primary content 338 (e.g., video plays for over a threshold amount of time), average view time, and the like. The content creation metrics 330 may include various metrics associated with creation/promotion of the content item. For example, content creation metrics 330 may include when a campaign including the content was launched and/or how much time is remaining in the campaign. The display settings 332 may enable the client to toggle various layers of the content performance view on and off.

Referring to FIG. 3D, in response to toggling a performance layer 346 of the content performance view on via the display settings 332, the content performance view 326b may be presented. In other embodiments, the performance layer 346 may be included in the initial view and be toggled off via the display settings 332. As shown in the illustrated embodiment, the performance layer 346 may be overlaid on the primary content 338 of the user-view layer 334. In many embodiments, the performance layer 346 may include a plot, such as a semi-transparent plot, including a time series of values for a user interaction metric corresponding to the primary content 338 (e.g., dismissal rate). Further, the client may be able to select portions of the plot, referred to as points of interest (POIs) to have more details provided as POI data 348. For example, the POI data 348 may include the dismissal rate and the corresponding time. Additionally, the portion of the primary content 338 displayed in the user-view layer 334 may be updated based on the POI. For example, the primary content 338 displayed in the user-view layer 334 may be updated to include the frame of the video corresponding to the POI. In many embodiments, this view provides new and useful computer functionality to enable a client to assess performance of content. For example, peaks in dismissal rate may serve to identify specific portions of the primary content 338 that are causing user interaction to cease. In one such example, a wall of text included in a video may correspond to a peak, or relatively high, dismissal rate. In another such example, introduction of a drawback to the focus of the content may correspond to a peak, or relatively high, dismissal rate. In yet another example, an important safety information (ISI) message in a video may correspond to a peak, or relatively high, dismissal rate. Continuing with this example, in response, a client may decide to move the ISI message from the beginning of the video to a later portion of the video. Accordingly, clients can readily be informed by surfacing data indicative of poor performing portions of the content.

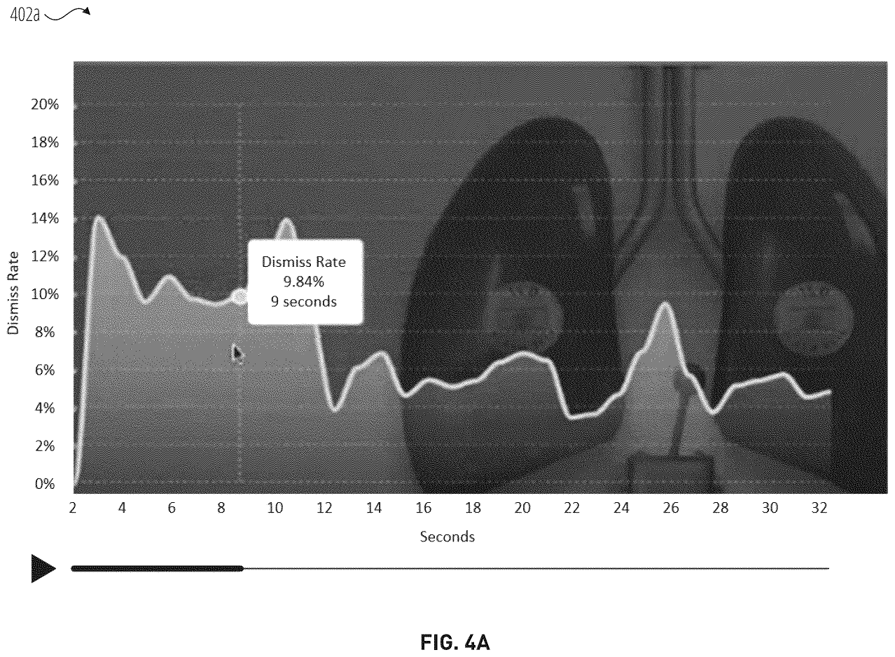

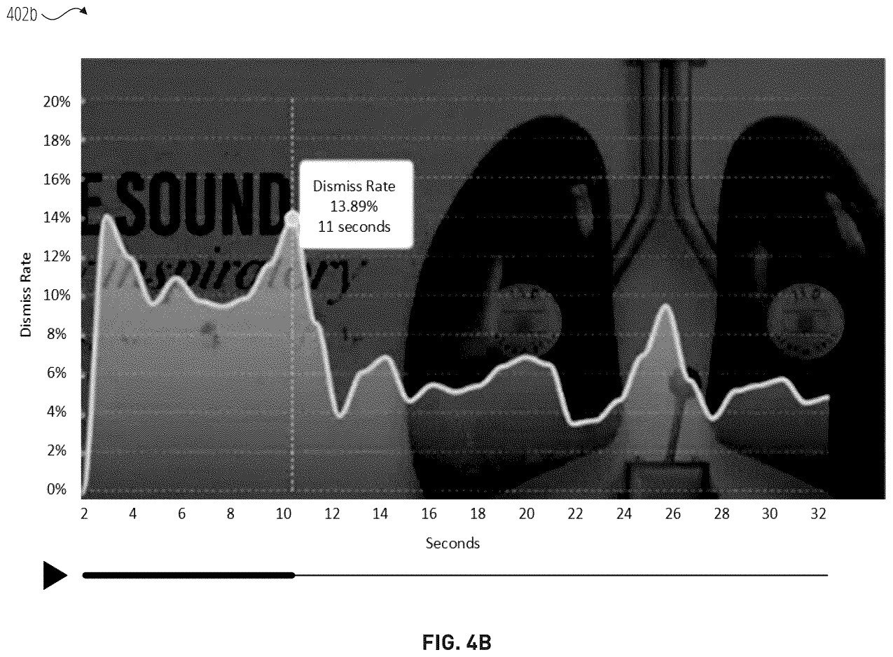

FIGS. 4A and 4B illustrate various content views 402a, 402b according to some embodiments. More specifically, the content view 402a of FIG. 4A includes an exemplary content performance view including a user-view layer and a performance layer corresponding to a first POI and the content view 402b of FIG. 4B includes an exemplary content performance view including a user-view layer and a performance layer corresponding to a second POI. As shown in FIGS. 4A and 4B, the portion of the content displayed on the user-view layer and the data displayed in the performance layer is updated based on the POI. Accordingly, in content view 402a a frame of the content corresponding to 9 seconds is displayed in the user-view layer and the numerical value of the dismissal rate at 9 seconds is displayed in the performance layer. Similarly, in content view 402b a frame of the content corresponding to 11 seconds is displayed in the user-view layer and the numerical value of the dismissal rate at 11 seconds is displayed in the performance layer. One or more components of FIGS. 4A and 4B may be the same or similar to one or more other components disclosed hereby. For example, content view 402a or content view 402b may be the same or similar to content performance view 326b. Further, aspects discussed with respect to various components in FIGS. 4A and 4B may be implemented by one or more other components from one or more other embodiments without departing from the scope of this disclosure. Embodiments are not limited in this context.

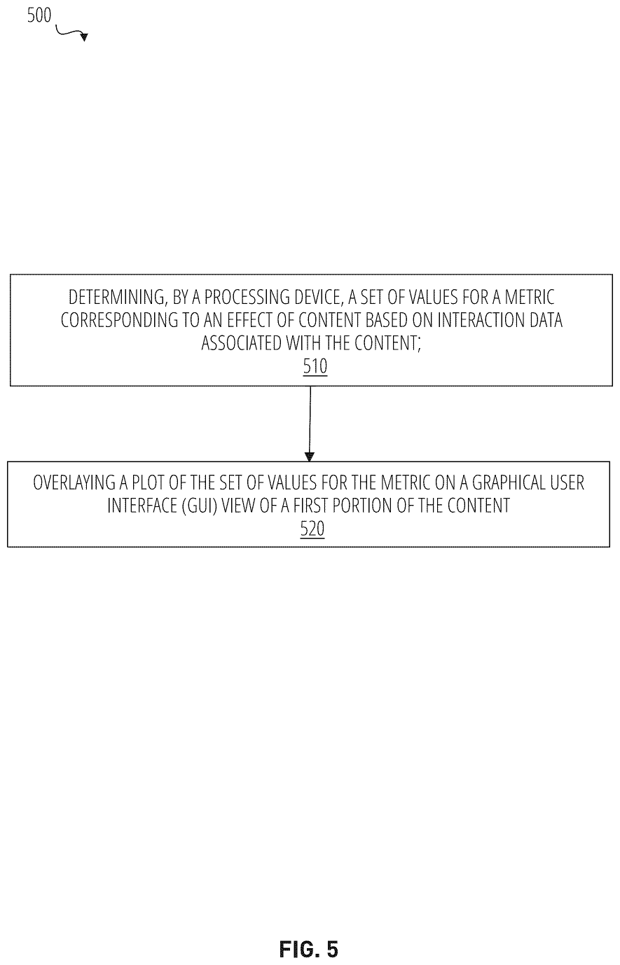

FIG. 5 is a flow diagram of a method 502 for supporting assessment of user interactions with content according to some embodiments. Method 502 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 502 may be performed through the execution of networking platform 110 by processing device 112 of FIG. 1.

With reference to FIG. 5, method 502 illustrates example functions used by various embodiments. Although specific function blocks (“blocks”) are disclosed in method 502, such blocks are examples. That is, embodiments are well suited to performing various other blocks or variations of the blocks recited in method 502. It is appreciated that the blocks in method 502 may be performed in an order different than presented, and that not all of the blocks in method 502 may be performed.

Method 500 begins at block 510, where the processing logic determines a set of values for a metric corresponding to an effect of content based on interaction data associated with the content. For example, performance metric manager 132 may determine a set of values for a metric (e.g., dismissal rate) corresponding to an effect of a video based on interaction data stored in datastore 138. At block 520, a plot of the metric may be overlaid on a GUI view of a first portion of the content. For example, the plot in the performance layer 346 of the content performance view 326b may be overlaid on the primary content 338 in the user-view layer 334 of the content performance view 326a.

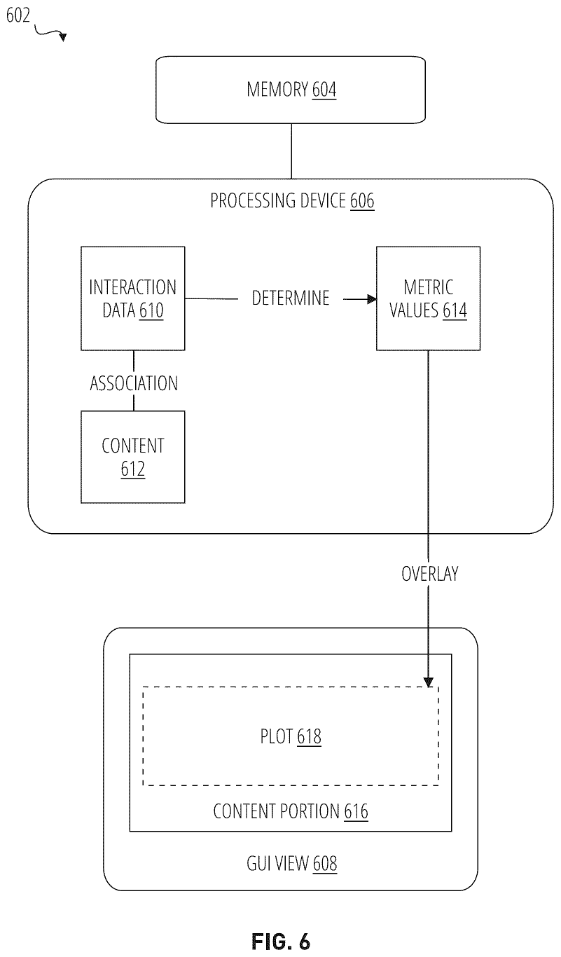

FIG. 6 illustrates a block diagram of a system 602 for supporting assessment of user interaction with content. In the illustrated embodiment, system 602 includes a memory 604, a processing device 606, and a GUI view 608. It should be noted that some components of system 602 are shown for illustrative purposes only and are not physical components of the system 602. One or more components of FIG. 6 may be the same or similar to one or more other components disclosed hereby. For example, processing device 606 may be the same or similar to processing device 112. In another example, plot 618 may be the same or similar to the plot in the performance layer 346 of FIG. 3D. Further, aspects discussed with respect to various components in FIG. 6 may be implemented by one or more other components from one or more other embodiments without departing from the scope of this disclosure. Embodiments are not limited in this context.

In system 602, the processing device 606 may determine metric values 614 corresponding to an effect of content 612 based on interaction data 610 that is associated with the content 612. For example, the processing device 606 may determine a set of values for a metric corresponding to dismissal of the content. In some embodiments, the metric may include a dismissal rate corresponding to user interactions with the content. A plot 618 of the metric values 614 may be overlaid on a GUI view 608 of a content portion 616. For example, content 612 may include a video and the content portion 616 may include a frame of the video. In many embodiments, the plot 618 may include a semi-transparent plot.

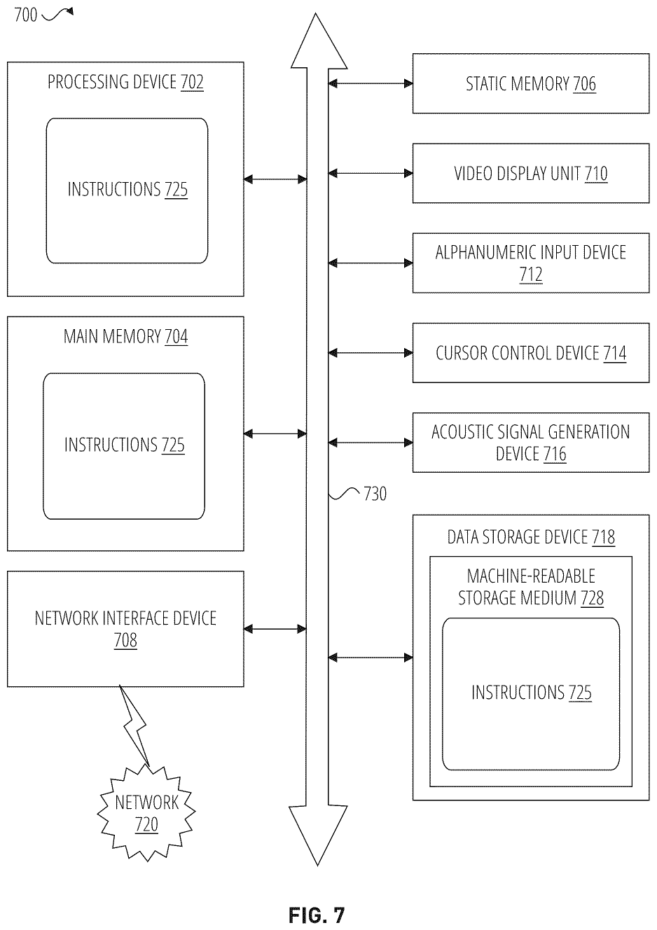

FIG. 7 is a block diagram of an example computing device 700 that may perform one or more of the operations described herein, in accordance with some embodiments of the disclosure. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device 702 (e.g., a general purpose processor, a PLD, etc.), a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), network processor, or the like. The processing device 702 may execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 816 (e.g., a speaker). In one embodiment, video display unit 710, alphanumeric input device 712, and cursor control device 714 may be combined into a single component or device (e.g., an LCD touch screen).

Data storage device 718 may include a machine-readable storage medium 728 on which may be stored one or more sets of instructions 725 that may include instructions for a component (e.g., one or more components of networking platform 110, user device 104, and/or client device 106) for carrying out the operations described herein, in accordance with one or more aspects of the present disclosure. Instructions 725 may also reside, completely or at least partially, within main memory 704 and/or within processing device 702 during execution thereof by computing device 700, main memory 704 and processing device 702 also constituting computer-readable media. The instructions 725 may further be transmitted or received over a network 720 via network interface device 708.

While machine-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

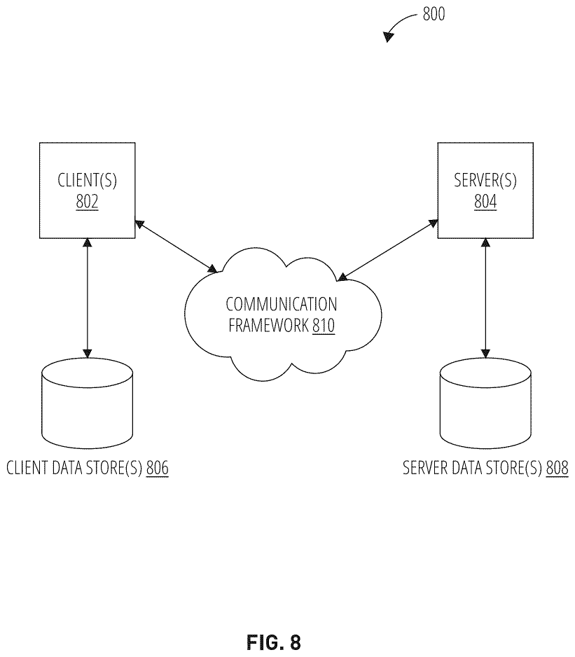

FIG. 8 is a block diagram depicting an exemplary communications architecture 800 suitable for implementing various embodiments as previously described, such as communications between client device 106 and computing device 102 and/or user device 104 and computing device 102, for example. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more client(s) 802 and server(s) 804. In some embodiments, each client 802 and/or server 804 may include a computing system (e.g., computing device 700). The server(s) 804 may implement one or more devices or components of networking platform 110. The client(s) 802 may implement one or more device or components of user device 104 and/or client device 106. The client(s) 802 and the server(s) 804 are operatively connected to one or more respective client data store(s) 806 and server data store(s) 808 that can be employed to store information local to the respective client(s) 802 and server(s) 804, such as cookies and/or associated contextual information. In various embodiments, any one of server(s) 804 may implement one or more logic flows or operations described hereby, such as in conjunction with storage of data received from any one of client(s) 802 on any of server data store(s) 808. In one or more embodiments, one or more of client data store(s) 806 or server data store(s) 808 may include memory accessible to one or more portions of components, applications, and/or techniques described hereby.

The client(s) 802 and the server(s) 804 may communicate information between each other using a communication framework 810. The communication framework 810 may implement any well-known communications techniques and protocols. The communication framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 802 and the server(s) 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other

Unless specifically stated otherwise, terms such as “presenting,” “determining,” “analyzing,” “retrieving”, “transforming”, “generating”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
determining, by a processing device, a set of values for a metric corresponding to an effect of content based on interaction data associated with the content; and
overlaying a plot of the set of values for the metric on a graphical user interface (GUI) view of a first portion of the content.

2. The method of claim 1, wherein the effect of the content corresponds to dismissal of the content, the plot comprises a semi-transparent plot, the GUI view of the first portion of the content comprises a first instance of a content performance view presented on a client GUI, the first instance includes a user-view layer and a performance layer, the user-view layer in the first instance includes the first portion of the content, the performance layer in the first instance includes the semi-transparent plot overlaid on the first portion of the content in the user-view layer, and the method further comprises:
determining a value in the set of values and a second portion of the content associated with the value, the value determined based on correspondence with a point of interest on the semi-transparent plot, and the point of interest identified based on client interaction data corresponding to the content performance view of the client GUI; and
causing presentation of second instance of the content performance view on the client GUI, the second instance including the user-view layer and the performance layer, the user-view layer in the second instance including the second portion of the content, and the performance layer in the second instance including the semi-transparent plot overlaid on the second portion of the content.

3. The method of claim 2, wherein the content includes a video, the first portion of the content includes a first frame of the video, and the second portion of the content includes a second frame of the video.

4. The method of claim 2, wherein the metric comprises a dismissal rate calculated based on a number of users viewing the content at first instant compared to a number of users viewing the content at a second instant preceding the first instant.

5. The method of claim 4, wherein the set of values comprise rolling averages of the dismissal rate.

6. The method of claim 2, wherein the interaction data associated with the content is generated based on input received at a user GUI implemented by a user plane of a networking platform and the client GUI is implemented via a client plane of the networking platform.

7. The method of claim 6, wherein the content is included in a content item and the content item is presented in the user-view layer of the first and second instance of the content performance view in a format utilized to present the content item to users via the user GUI.

8. The method of claim 2, wherein the performance layer in the second instance of the content performance view displays a number for the value corresponding to the point of interest on the semi-transparent plot.

9. The method of claim 2, further comprising:
analyzing first data received via a network to identify a content item including the content based on client input received via a content library view of the client GUI, the client GUI implemented by a client plane of a networking platform;
retrieving, in response to identifying the content item, interaction data from a data store, the interaction data generated based on interaction data associated with the content of the content item; and
transforming the interaction data into the set of values corresponding to the metric.

10. The method of claim 9, wherein transforming the interaction data into the set of values for the metric includes:
identifying a set of users that interacted with the content;
determining a longest amount of time each user in the set of users interacted with the content; and
generating the set of values for the metric based on the longest amount of time each user in the set of users interacted with the content item.

11. A system comprising:
a memory; and
a processing device, operatively coupled to the memory, to:
determine a set of values for a metric corresponding to an effect of content based on interaction data associated with the content; and
overlay a plot of the set of values for the metric on a graphical user interface (GUI) view of a first portion of the content.

12. The system of claim 11, wherein the effect of the content corresponds to dismissal of the content, the plot comprises a semi-transparent plot, the GUI view of the first portion of the content comprises a first instance of a content performance view presented on a client GUI, the first instance includes a user-view layer and a performance layer, the user-view layer in the first instance includes the first portion of the content, the performance layer in the first instance includes the semi-transparent plot overlaid on the first portion of the content in the user-view layer, and the processing device is further configured to:
determine a value in the set of values and a second portion of the content associated with the value, the value determined based on correspondence with a point of interest on the semi-transparent plot, and the point of interest identified based on client interaction data corresponding to the content performance view of the client GUI; and
cause presentation of second instance of the content performance view on the client GUI, the second instance including the user-view layer and the performance layer, the user-view layer in the second instance including the second portion of the content, and the performance layer in the second instance including the semi-transparent plot overlaid on the second portion of the content.

13. The system of claim 12, wherein the content includes a video, the first portion of the content includes a first frame of the video, and the second portion of the content includes a second frame of the video.

14. The system of claim 12, wherein the metric comprises a dismissal rate calculated based on a number of users viewing the content at first instant compared to a number of users viewing the content at a second instant preceding the first instant.

15. The system of claim 14, wherein the set of values comprise rolling averages of the dismissal rate.

16. A non-transitory computer-readable storage medium including instructions that, when executed by a processing device, cause the processing device to:
determine, by the processing device, a set of values for a metric corresponding to an effect of content based on interaction data associated with the content; and
overlay a plot of the set of values for the metric on a graphical user interface (GUI) view of a first portion of the content.

17. The non-transitory computer-readable storage medium of claim 16, wherein the effect of the content corresponds to dismissal of the content, the plot comprises a semi-transparent plot, the GUI view of the first portion of the content comprises a first instance of a content performance view presented on a client GUI, the first instance includes a user-view layer and a performance layer, the user-view layer in the first instance includes the first portion of the content, the performance layer in the first instance includes the semi-transparent plot overlaid on the first portion of the content in the user-view layer, and the processing device is further configured to:
determine a value in the set of values and a second portion of the content associated with the value, the value determined based on correspondence with a point of interest on the semi-transparent plot, and the point of interest identified based on client interaction data corresponding to the content performance view of the client GUI; and
cause presentation of second instance of the content performance view on the client GUI, the second instance including the user-view layer and the performance layer, the user-view layer in the second instance including the second portion of the content, and the performance layer in the second instance including the semi-transparent plot overlaid on the second portion of the content.

18. The non-transitory computer-readable storage medium of claim 17, wherein the interaction data associated with the content is generated based on input received at a user GUI implemented by a user plane of a networking platform and the client GUI is implemented via a client plane of the networking platform.

19. The non-transitory computer-readable storage medium of claim 18, wherein the content is included in a content item and the content item is presented in the user-view layer of the first and second instance of the content performance view in a format utilized to present the content item to users via the user GUI.

20. The non-transitory computer-readable storage medium of claim 17, wherein the performance layer in the second instance of the content performance view displays a number for the value corresponding to the point of interest on the semi-transparent plot.
